(19) United States
(12) Patent Application Publication
(10) Pub. No.: US 2005/0081523 A1
(43) Pub. Date: Apr. 21, 2005

(54) Charged internal combustion engine

(76) Inventors: Thomas Breitling, Motzingen (DE); Wolfgang Kleineberg, Calw (DE)

Correspondence Address: KLAUS J. BACH, 4407 TWIN OAKS DRIVE, MURRYSVILLE, PA, 15668, US

(21) Appl. No.: 10/965,572

(22) Filed: Oct. 14, 2004

(30) Foreign Application Priority Data
Oct. 16, 2003 (DE) 103 48 136.02

(51) Int. Cl. F02B 29/04

(52) U.S. Cl. 60/599; 123/563

(57) ABSTRACT

In an internal combustion engine for a motor vehicle having an intake air charger for increasing the pressure of the air supplied to the engine, a charge air cooler for cooing the charge air supplied to the engine and a control arrangement for controlling the temperature of the charge air flow to the engine, the control arrangement includes an air flow control element arranged in the charge air cooler for blocking at least sections of the charge air cooler so as to reduce the effective heat exchange surface area in the charge air cooler depending on operating parameters.

### BACKGROUND OF THE INVENTION

The invention relates to a charged internal combustion engine for a motor vehicle including a charging device in which intake air is compressed, a charge air cooler which cools the compressed intake air and a control arrangement for controlling the temperature of the air leaving the charge air cooler.

DE 25 53 821 A1 discloses an internal combustion engine with a charger which controls the temperature of the charge air supplied to the engine from the charge air cooler of the engine. The charge air cooler is provided with a flap which is operated by a control arrangement so that the cooling air flow through the charge air cooler is adjustable. If the flap for example closes the charge air cooler, the charge air is not cooled at all. If the flap is open and permits unrestricted passage of cooling air through the cooler the charge air is cooled to the maximum extent. The arrangement permits an advantageous adjustment of the charge air for the internal combustion engine depending on its operating conditions.

It is the object of the present invention to provide an arrangement for controlling the charge air temperature for an internal combustion engine without the need for controlling the cooling air flow through the charge air cooler.

### SUMMARY OF THE INVENTION

In an internal combustion engine for a motor vehicle having an intake air charger for increasing the pressure of the air supplied to the engine, a charge air cooler for cooing the charge air supplied to the engine and a control arrangement for controlling the temperature of the charge air flow to the engine the control arrangement includes an air flow control element arranged in the charge air cooler for blocking at least sections of the charge air cooler so as to reduce the effective heat exchange surface area in the charge air cooler depending on operating parameters.

The air flow control element guides the charge air flow through the charge air cooler in such a way that selectively only parts of the available cooling surface area of the charger air cooler is contacted by the charge air. The cooling elements of the charge air cooler are for example in the form of parallel flat or oval tubes. The charge air transfers heat to the surface of the cooling elements. The flow control element closes a part of the cooling elements through which the charge air flows either partially or fully depending on engine operating parameters such as coolant temperature, engine load, exhaust gas emissions, power- and torque requirements and/or ambient temperature. In the cooling elements, which are left open, the air flow speed increases greatly because of the reduced flow cross-section. With the increased flow speed and the reduced cooling area, the cooling effect of the charge air is greatly reduced.

In a particular embodiment of the invention, the air flow control element is arranged in an air collector housing of the charge air cooler. The charge air cooler includes two air collector housings. In the first air collector housing, the charge air is distributed so that it flows from there, uniformly distributed, through the cooling elements and is again collected in the second air collector housing. From the second air collector housing, the charge air flows to the various cylinders of the internal combustion engine. The flow control element can therefore be arranged either at the inlet end or at the outlet end of the charge air cooler. Its arrangement in an air collector housing requires essentially no additional space. Furthermore, the charge air cooler can be pre-assembled with the air flow control element and provided as complete, fully assembled unit.

The air flow control element is a rectangular or a round flap which is rotatably supported by a shaft. When the flap extends normal to the flow direction of the charge air, the cooling surface area of the charge air cooler is maximally reduced. When the flap extends parallel to the charge air flow direction, there is no reduction in the charge air cooling effect. Such a rotatable flap is inexpensive to manufacture and requires little space.

The air flow control element is preferably adjustable by a controller to which the shaft of the flap is connected. By the actuation of such a controller, the temperature of the charge air leaving the charge air cooler can be advantageously adjusted. The controller is for example in the form of a control motor or a vacuum adjuster.

In one embodiment of the invention the charge air is cooled in the charge air cooler by cooling air, preferably by the airflow of the vehicle. The cooling air flows through the spaces between the cooling elements of the charge air cooler. The charge air flowing in the cooling elements transmits heat energy to the cooling air by way of the walls of the cooling elements. Such air-cooled charge air coolers are inexpensive to manufacture.

In another embodiment, the charge air is cooled in the charge air cooler by a liquid coolant, preferably coolant of the engines cooling circuit. The coolant flows through passages between the cooling elements of the charge air cooler whereby the charge air flowing through the cooling elements transfers heat energy to the coolant. The location of such liquid cooled charge air coolers is freely selectable. Such liquid cooled coolers are also quite small and require little installation space.

In a particular embodiment of the invention, the air collection housing of the charge air cooler includes an air flow channel which is formed by parts of the air collector housing and/or additional divider walls and which is in communication with a part of the cooling tubes of the charge air cooler. In the air flow channel a flap is arranged by which the air flow channel can be fully or partially closed. The air channel is in communication with cooling tubes of the charge air cooler. The air channel is formed by divider walls and by housing parts of the air collector housing. The divider walls are preferably formed integrally with the air collector housing which consists preferably of a plastic or metallic material. When the flap is closed, no charge air is cooled in the cooling tubes which are in communication with the air flow channel. All of the charge air then flows through the charge air cooler by way of the still open cooling tubes. When the flap is open, the charge air flows through all the cooling tubes of the charge air cooler. Because of the utilization of the air collector housing for the air flow control element, the arrangement is relatively small and requires little installation space.

The invention will become more readily apparent from the following description of particular embodiments on the basis of the accompanying drawings.

### BRIEF DESCRIPTION OF THE DRAWINGS

FIG. 1 shows schematically an internal combustion engine according to the invention,

FIG. 2 shows a charge air cooler as it is incorporated in the engine arrangement of FIG. 1, and

FIG. 3 is a cross-sectional view of the charge air cooler of FIG. 2.

### DESCRIPTION OF A PREFERRED EMBODIMENT

In the figures, identical components are indicated by the same reference numerals.

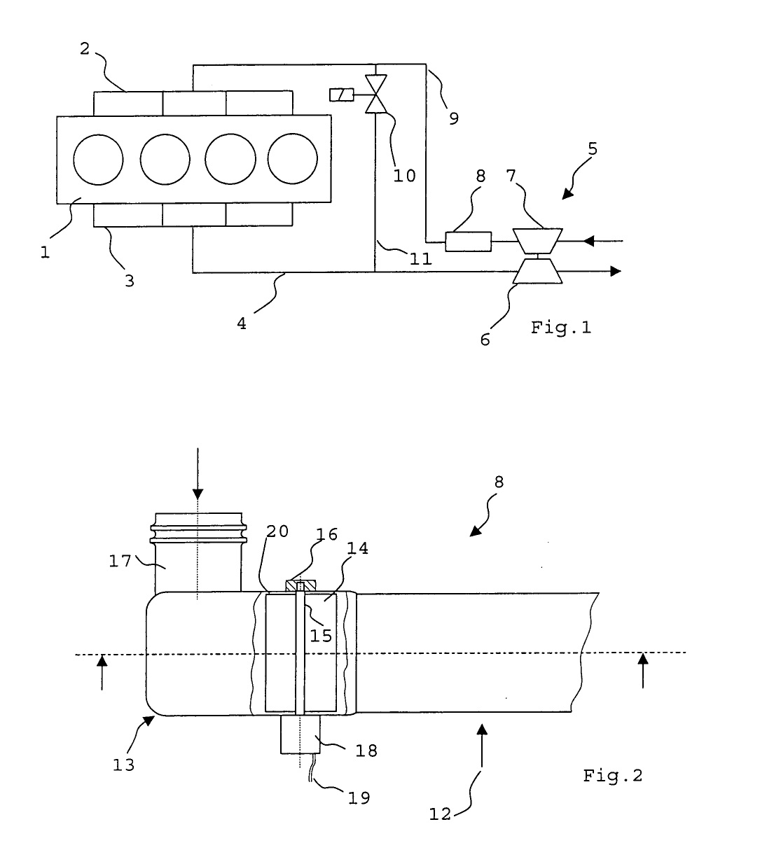

FIG. 1 shows schematically a charged internal combustion engine with exhaust gas recirculation. The internal combustion engine comprises an engine block 1 with a crankcase and a cylinder head having an intake manifold 2 and an exhaust manifold 3. It also includes a charge air supply arrangement 5 comprising an exhaust gas turbocharger with a charge air cooler 8.

In the motor block 1, the combustion of the gas-air mixture occurs. Air flows to the motor block 1 by way of the intake manifold 2. Fuel is added to the air by the injection of fuel into the intake duct or into the cylinders. Exhaust gas generated by the combustion of the mixture flows by way of the exhaust manifold 3 into an exhaust duct 4 which is connected to an exhaust gas turbocharger 5.

The exhaust gas turbocharger includes a turbine 6 and a compressor 7. The exhaust gas flowing into the exhaust gas turbocharger 5 drives the turbine 6 which is mechanically coupled to a compressor 7. The compressor 7 compresses the inducted fresh air which then flows by way of a charge air duct 9 to the intake manifold 2 and the combustion chambers in the engine block 1.

In a modified embodiment, which is not shown, the intake air is compressed by a mechanical charger which is driven by the crankshaft of the engine.

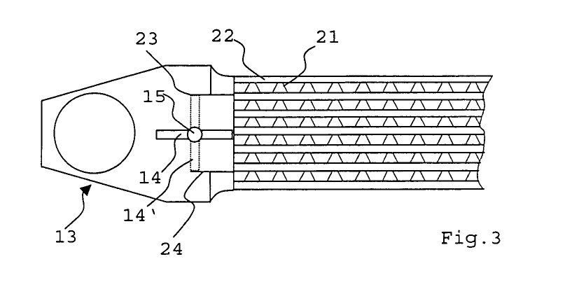

The charge air duct 9 includes a charge air cooler 8 in which the charge air is cooled. This reduces the thermal load of the engine and results in lower NOₓ emissions in the exhaust gas. Furthermore, with a decrease in the charge air temperature, the charge air density is increased which results in an improved degree of filling of the cylinders of the engine and consequently in an increase in the power output. The induction air compressed in the turbocharger 5 transfers in the charge air cooler 8 heat energy to a cooling medium. As shown in FIGS. 2 and 3, the charge air is cooled in the charge air cooler 8 by a flow of cool ambient air 12. The cool air flow is generated by the vehicle speed or by a fan.

In another embodiment, the charge air is cooled in a charge air cooler 8 through which the coolant of the internal combustion engine flows.

Exhaust gas is re-circulated by way of an exhaust gas re-circulation line 11. The exhaust gas re-circulated to the combustion chamber reduces the combustion temperature peaks and reduces the NOₓ formation. An exhaust gas recirculation valve 10, which is controlled by an engine control unit, which is not shown, controls the exhaust gas recirculation rates.

FIG. 2 shows an air cooled charge air cooler 8. The charge air flows by way of inlet nozzle 17 into an air collection housing 13 of the charge air cooler 8. In the air collection housing 13, the charge air is uniformly distributed and directed into the cooling element 22 which are for example heat exchange tubes. Between the heat exchange tubes 22 cooling ribs 21 are arranged which improve the heat transfer from the charge air to the cooling air flowing through the charge air cooler 8. Through a discharge nozzle of the charge air cooler 8, which is not shown, the cooled charge air flows by way of the charge air line to the intake manifold 2 of the engine motor block 1 shown in FIG. 1.

In the collector housing 13 of the charge air cooler 8, there is an air flow control element 14 in the form of a rectangular flap which, as shown in FIG. 2, is mounted on a pivotally supported shaft 15. The shaft 15 is supported by a friction bearing 16 and connected to an operator 18. The operator 18 is a control motor which is controlled by a control device which is not shown. The control device is connected to the control motor 18 by an electrical line 19. At the axial ends, the flap 14 seals against the charge air collector housing 13 by way of a small gap 20; at the radially outer edges the flap 14 is sealed by the small gaps 23 with respect to a divider wall 24 arranged in the air collector housing 13. The sizes of the flap 14 and the respective air flow channel are so selected that the closed flap 14′ closes off the major part of the heat exchange tubes 22. In the embodiment as shown in FIG. 3, only two heat exchange tubes 22 are left open when the flap 14′ is closed. If in the charge air cooler several heat exchange tubes 22 are arranged behind one another in the flow direction of the cooling air, charge air flows through all the tubes arranged in that flow plane when the flap 14′ is closed. The size of the flap 14 and consequently the corresponding amount of heat exchange tubes 22 left open when the flap 14′ is closed depends of course on the requirements of the engine for which the charge air cooler is provided.

Highly efficient internal combustion engines such as turbocharged Diesel engines with direct fuel injection release only relatively little heat to the coolant in the lower load range. As a result, the passenger compartment cannot be heated sufficiently. In order to avoid the use of expensive auxiliary heating systems, the heating of the internal combustion engine after start-up may be accelerated. The higher the induction air temperature, the less time it takes to heat up the engine. The charge air is heated by its compression in the turbocharger 5; its cooling in the charge air cooler 8 shown in FIGS. 2 and 3 can advantageously be prevented. With the flap 14 in the charge air collector housing 13 of the charge air cooler part of the heat exchange tubes 22 can be closed depending on the engine operating temperatures during low load operation of the engine and at low coolant temperatures. In this way, the cooling surface area of the charge air cooler is reduced. The cooling of the charge air flowing through the charge air cooler 8 is therefore reduced and heat-up of the engine is accelerated.

It is noted that the flap 14 does not need to be rectangular, it may be for example of square shape or round

Also, the air flow passages may be formed exclusively by divider walls 24, that is, without the inclusion of parts of the housing walls of the air collector housing 13.

In the closed position of the flap, the charge air flow resistance is increased and more energy is needed for supplying the charge air to the engine which also contributes to a more rapid heating of the engine. Because of the throttling of the charge air and the resulting pressure conditions, with a corresponding control of the exhaust gas recirculation valve 10, the exhaust gas recirculation rate can be increased. With an increase in the exhaust gas recirculation rate, the excess air volume of the internal combustion engine is decreased and the combustion temperature is increased. The increase of the combustion temperature also results in a more rapid heating of the coolant whereby the heating capability of the engine for heating the passenger compartment is improved.

1. An internal combustion engine (1) for a motor vehicle having an intake air charger (5) for increasing the pressure of the air supplied to the engine (1), a charge air cooler (8) for cooling the charge air supplied to the engine (1), and a control arrangement for controlling the temperature of the charge air flow supplied to the engine (1), said control arrangement including an air flow control element (14) arranged in the charge air cooler (8) for blocking at least sections of the charger air cooler (8) for reducing the effective heat exchange surface area in the charge air cooler (8) depending on engine operating parameters.

2. An internal combustion engine according to claim 1, wherein the charge cooler (8) includes an air collection housing (3) and the air flow control element (14) is arranged in the air collection housing (3).

3. An internal combustion engine according to claim 1, wherein the air flow control element (14) is in the form of a pivotable flap.

4. An internal combustion engine according to claim 1, wherein the airflow control element (14) is adjustable by a control motor (18).

5. An internal combustion engine according to claim 1, wherein the charge air is cooled in the charge air cooler (8) by an ambient air flow (12).

6. An internal combustion engine according to claim 1, wherein the charge air is cooled in the charge air cooler (8) by a liquid coolant.

7. An internal combustion engine according to claim 2, wherein an air flow channel is formed in the air collection housing (13) in the charge air cooler (8) which comprises part of the air collection housing (13) and dividing walls (24) and which is in communication with only part of the heat exchange tubes (22) of the charge air cooler (8) and the air flow control element (14) is arranged in the air flow channel for at least partially closing the air flow channel.

8. An internal combustion engine according to claim 7, wherein the flap (14) is of rectangular shape.

9. An internal combustion engine according to claim 1, wherein the intake air charger (5) is an exhaust gas turbocharger.
